(19) United States
(12) Patent Application Publication
(10) Pub. No.: US 2005/0138933 A1
(43) Pub. Date: Jun. 30, 2005

(54) Pulse detonation engine and method for initiating detonations

(76) Inventor: Jon Tegner, Stockholm (SE)

Correspondence Address: JACOBSON HOLMAN PLLC, 400 SEVENTH STREET N.W., SUITE 600, WASHINGTON, DC, 20004, US

(21) Appl. No.: 10/502,050

(22) PCT Filed: Jan. 30, 2003
(86) PCT No.: PCT/SE03/00159

(30) Foreign Application Priority Data
Jan. 30, 2002 (SE) 0200263-2

(51) Int. Cl. F02C 5/00

(52) U.S. Cl. 60/776; 60/39.76

(57) ABSTRACT

The invention relates to a pulse detonation engine and a method for initiating detonations in a pulse detonation engine. The pulse detonation engine (1) comprises a combustion chamber (2), an igniting device (3) and a fuel injection device (4) with a plurality of injection valves (5) arranged in the axial direction (20). The injection valves (5) are arranged in the longitudinal direction of the engine for sequence-controlled injection of fuel (6) into the combustion gases (7) remaining from the preceding detonation. This provides a mixture of fuel and free radicals that facilitates the forming of a detonation.

The invention relates to a pulse detonation engine and a method for initiating detonations in a pulse detonation engine with a plurality of longitudinally positioned nozzles for fuel injection and, more specifically, a plurality of injection valves arranged in the longitudinal direction of the engine for controlled injection of a fuel/air mixture into the remaining combustion gases.

The pulse detonation engine is an engine of the type that consumes air and has about the same applications as the jet engine. In contrast to the jet engine, the pulse detonation engine has a considerably smaller number of moving parts and utilises intermittent combustion of the fuel instead of continuous. An introduction to the pulse detonation engine is to be found in the journal “Militärteknisk tidskrift” (Swedish Journal of Military Technology), No. 4 (2001), pp 2629, “An Introduction to the Pulse Detonation Engine” written by Jon Tegnér. The Patent Publications U.S. Pat. No. 2,612,784, U.S. Pat. No. 2,860,484, CH 283,880 and DE 1 022 912 also disclose pulse detonation engines.

In a pulse detonation engine (PDE), the combustion chamber is filled with a detonatable mixture of air and fuel. The fuel can be a gas, for instance acetylene or hydrogen, consist of liquid particles (aerosol) of e.g. jet propulsion fuel or consist of a highly atomised powder of e.g. boron or carbon. The air can be drawn in through air intakes, or else a brought along oxidiser can be used.

The greatest difficulty in obtaining a functioning air breathing pulse detonation engine is the initiation of the detonation in each cycle. It is possible to distinguish two different methods (which have several characteristics in common) of initiating the detonation; direct initiation and initiation by transition from deflagration.

To cause a direct initiation (for instance by an ignition plug, an exploding wire or a fuse head) hundreds of Joules are required for e.g. acetylene mixed with air. This is not reasonable in an engine where the detonation has to be initiated up to 100 times a second. In order to reduce the energy required, the fuel/air mixture can be enriched with oxygen or other substances which make the mixture more sensitive. However this has the drawback that the specific impulse of the engine is reduced.

When initiating by transition from deflagration to detonation, not very great amounts of energy are required. The mixture is ignited, for instance by an ignition plug, after which the flame accelerates up to the speed of detonation. The transition, however, is slow as the flame has to propagate a longer distance before it reaches the speed of detonation and the transition is completed. Like in direct initiation, also this method is affected if the mixture is made more sensitive (for instance by enrichment with oxygen), which results in the transition being more rapid, but also in a reduction of the specific impulse of the engine.

For a pulse detonation engine to be effective, it is critical for the initiation to be optimised in such a manner that the amount of energy, the amount of extra additives (for instance oxygen) and the length of the transition zone are minimised. Besides it is desirable to be able to use standard fuels, i.e. fuels that are neither expensive nor excessively difficult to handle (e.g. toxic, environmentally dangerous or susceptible to shocks). What the two methods of initiating the detonation as described above have in common is the creating of the critical conditions in the field of flow that is necessary for the detonation to be formed. In direct initiation, these conditions are created by the initial shock wave which is of such strength that the combustion takes place in direct connection therewith, thereby forming the detonation more or less directly.

In transition from deflagration, the critical conditions that are necessary for the detonation to be formed are the result of turbulence (small-scale phenomenon), whirls (large-scale phenomenon) and shock waves, and their effect on the field of flow. Turbulence, whirls and shock waves are a consequence of the increasing velocities of flow of the medium (and also dependent on the formation of the inner geometry of the tube), and their effects increase in strength as the burning surface of the flame increases. In the cases where a transition to detonation takes place, the critical conditions are a consequence of an unstable process where turbulence, whirls and shock waves are included. This means that greater whirls and increasing turbulence cause a larger burning surface, which in turn results in still greater whirls and further increasing turbulence etc. Moreover, the actual transition to detonation is facilitated by the rise in temperature in the shock waves.

The invention discloses a pulse detonation engine and a method that makes it possible to initiate detonations with a minimum of energy and extra additives, without having to rely on fuels that are difficult to handle and/or expensive. It is also possible to avoid a certain minimum diameter of the engine that was previously necessary, and higher maximum thrust and specific impulse can be achieved than is possible with prior-art pulse detonation technique.

In the present pulse detonation engine and method, a pulse detonator engine is disclosed, having a plurality of injection valves arranged in the longitudinal direction of the engine for injection of fuel into the remaining combustion gases.

The invention will now be described in more detail with reference to the accompanying Figures.

FIG. 1 shows a pulse detonation engine according to the invention.

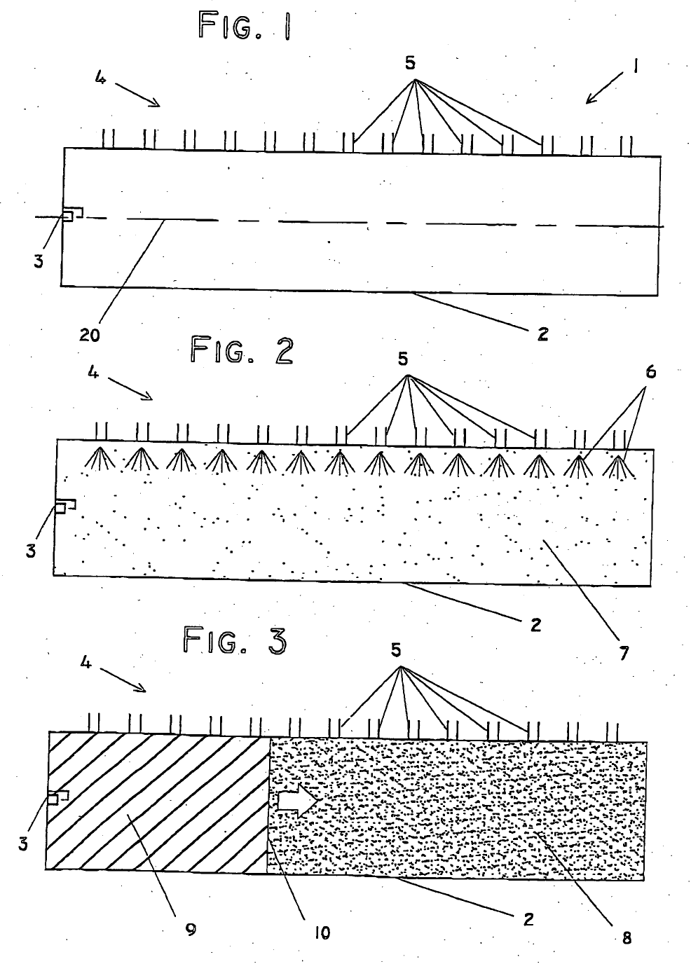

FIG. 2 shows the injection stage according to a first method.

FIG. 3 shows the detonation front.

FIG. 4 shows when the detonation has left the combustion chamber and a cycle is completed.

FIG. 5 shows the beginning of the injection according to a second method.

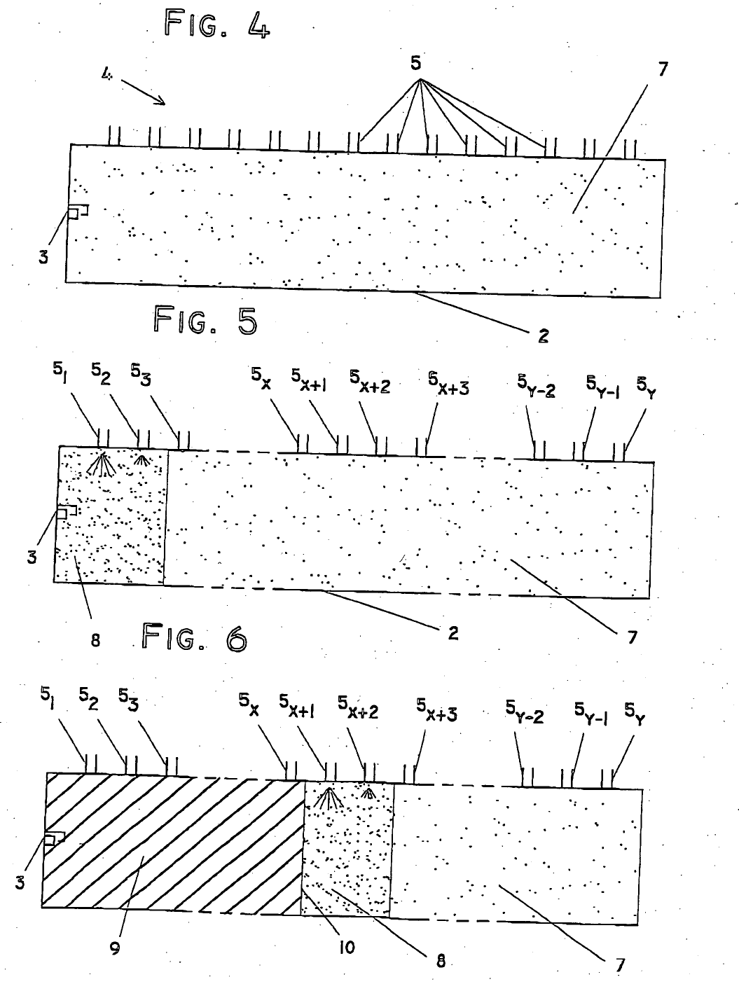

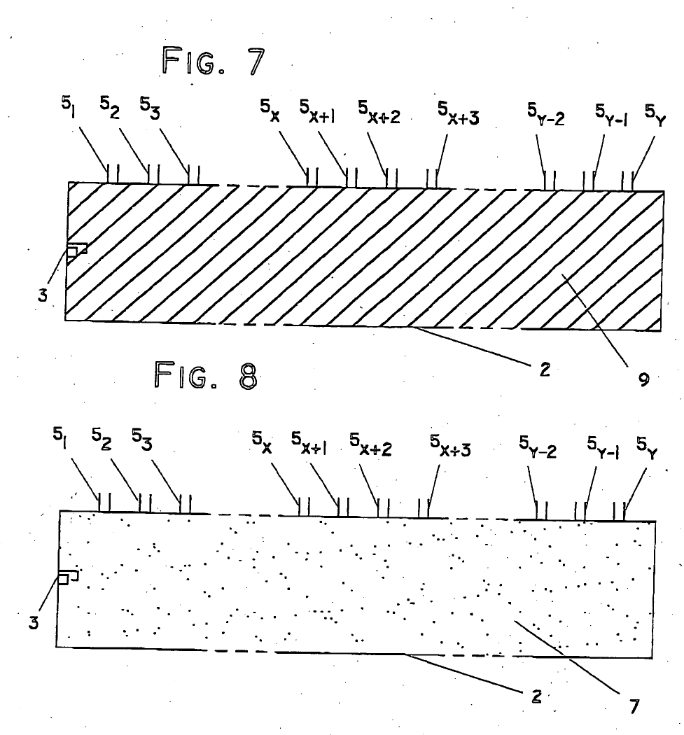

FIGS. 6-7 show injection and the propagation of the detonation front.

FIG. 8 shows when the detonation has left the combustion chamber and a cycle is completed.

The invention is described below starting from the second pulse. The first pulse produced in the pulse detonation engine will not give full effect but is necessary to create conditions so that the second and subsequent pulses can give full effect. The use of the residual products after a previous pulse also means that the pulse detonation engine does not have a device to clean the combustion chamber after each pulse.

FIG. 1 shows a pulse detonation engine according to the invention. The pulse detonation engine (1) comprises a combustion chamber (2) with an igniting device (3) at one end, and a fuel injection device (4) comprising a plurality of injection valves (5). The injection valves (5) are arranged in the longitudinal direction (20) of the combustion chamber. In this manner, the combustion chamber (2) can be more quickly filled with new fuel after the pulse has left the combustion chamber (2), compared with the arrangement of injection valves (5) merely at one end of the combustion chamber (2). FIG. 2 shows injection of a fuel/air mixture (6) after a pulse has left the pulse detonation engine. According to this first embodiment, all valves (5) open simultaneously and inject fuel/air (6) into the combustion chamber (2). The fuel/air mixture is there mixed with combustion products (7) that remain from the preceding combustion. These combustion products (7) contain, inter alia, free radicals. Free radicals are residual products that arise after an incomplete combustion, inter alia, oxygen atoms and OH molecules. One of the main principles of the invention is that the presence of these radicals facilitates the formation of a detonation. Moreover, the combustion products (7) are hot and heat the pulse detonation engine (1). The heat increases the temperature of the mixture in the combustion chamber (2), which also facilitates the formation of the detonation.

FIG. 3 shows how the detonation front (10) propagates through the combustion chamber (2). Fuel/air (6) and the combustion products (7) are mixed and form a mixture (8) which easily detonates. In the combustion chamber (2), the mixture (8) detonates as the detonation front (10) propagates. In FIG. 4, the detonation front has left the combustion chamber and leaves combustion products (7) behind which can be used by the next pulse.

A second embodiment of the fuel injection is shown in FIG. 5. Here not all valves open simultaneously, but in a predetermined order, sequence control. First the valve (5₁) closest to the igniting device (3) opens. Fuel/air is injected into the remaining combustion gases, which by means of the free radicals facilitate the formation of the detonation. The mixture (8) is then ignited by the igniting device (3). The formed detonation has a detonation front (10) propagating through the combustion chamber (2), see FIG. 6. Before the detonation front (10) reaches the next valve, it opens and injects fuel/air which detonates when the detonation front arrives. The detonation is maintained by the high pressure caused by the detonation front when propagating in the combustion chamber. The process is also shown with four arbitrary valves (5ₓ, 5ₓ₊₁, 5ₓ₊₂, 5ₓ₊₃). The first valve (5ₓ) is closed as the detonation front (10) has already passed and detonated the fuel/air mixture injected by that valve into the combustion chamber. The second valve (5ₓ₊₁) is fully open and is just going to be closed when the detonation front (10) soon detonates the injected fuel/air mixture. The third valve (5ₓ₊₂) starts to open and the fourth valve (5ₓ₊₃) has not yet opened.

In FIG. 7, the detonation front has just left the combustion chamber (2). In FIG. 8, the detonation has left the combustion chamber (2) and combustion products (7) remain, which start to be mixed with fuel according to FIG. 5 in order to produce the next pulse.

An advantage of sequence-controlled injection is that the fuel/air mixture is in contact with the free radicals for a shorter period of time. The contact with the radicals facilitates not only the formation of detonation but may also result in ignition of the mixture. That the fuel/air mixture is ignited before the detonation front has arrived gives a reduced effect and should be avoided if a maximum effect is to be achieved.

The control of the valves can be carried out, for instance, by means of a camshaft. The number of injection valves (5ₓ) should be more than two, the upper limit being mainly determined by what is practically feasible. A larger number of injection valves make it easier to control the pulse. In small pulse detonations engines, five injection valves can provide sufficient control whereas larger engines may need 18-20 injection valves and, if enough space is available, 100 valves or even more.

The invention is based on three principles. The first is that the formation of the detonation is facilitated when free radicals are present in the medium before the detonation is initiated, and at increased temperatures of the unconsumed medium. Free radicals and an increased temperature of the unconsumed medium will also decrease the minimum diameter that is necessary in a tube for a stable detonation to be able to propagate through the tube.

The second principle is that the transition to detonation may be described as a “convected explosion” where the explosion limits for different points in space are achieved in a time sequence corresponding to the sonic speed of the burned gases. In a successful transition, this results in a gradually increasing pressure which finally reaches such levels that the combustion is connected to the shock wave, and the detonation is formed. The expression convected explosion is described in more detail in, for instance, “ICASE/NASA LaRC series “Major Research Topics in Combustion” M. Y. Hussaini, A. Kumar, R. G. Voigt; ch. “On the Transition from Deflagration to Detonation” by Joseph E. Shepherd & John H. S. Lee; published by Springer Verlag.

The third principle is that if the combustible medium reacts and is consumed—wholly or partly—before the detonation arrives, the efficiency of the engine will be deteriorated. The reason for this is that in this case combustion takes place under a considerably lower pressure than is achieved in combustion in detonation form and thus achieves a lower efficiency.

The device and the method according to the invention utilise the above principles by utilising in each pulse heat and the free radicals remaining from the preceding pulse. Fuel and air is injected through a number of valves distributed in the longitudinal direction of the engine, where efficient mixing between the cold gases (fuel and air) and the hot combustion gases is aimed at. It is here important to note that the sensitivity of this mixture is considerably greater than that of the cold gases only (principle 1). Injection through the valves can take place in a time sequence which is adjusted to the sensitivity of the medium (the mixture between the cold unconsumed gases and the residual products from the preceding cycle). This means that if the medium is sufficiently sensitive, the initiation is no problem, and the important thing is instead to prevent combustion before the detonation arrives (according to principle 3). If the medium is instead insensitive, the initiation can be provoked by selecting a speed of the time sequence that corresponds with that of principle 2. In both these cases, it is optimal to select a speed close to the detonation speed (CJ (Chapman-Jouguet) speed) of the medium.

As has been made evident by that stated above, the method utilises hot residual products in the initiation of each new detonation. This means that some kind of igniting device is necessary to ignite the first pulse, and that the combustion in this first pulse will not take place in the form of a detonation, and consequently not generate full performance either. On the other hand, depending on the sensitivity of the medium and the frequency at which the detonations are repeated, the engine can, but need not; in steady state operate without an igniting device, i.e. the hot residual products and the hot structures of the engine are sufficient to ignite the next cycle.

An important advantage of the invention is that the detonation is initiated with a minimum of energy supplied, without extra additives and without having to use fuels that are difficult to handle or expensive. Moreover, the following advantages may be mentioned: the increased sensitivity that is achieved by mixing the gases with the hot residual products makes the detonation propagate through tubes with smaller diameters than would otherwise be possible. This is most important when small engines are to be constructed (for instance for use in UAVs (Unmanned Aerial Vehicles)). By injecting fuel and air at a plurality of stations, a higher maximum frequency and thus also higher thrust can be achieved (by using a plurality of valves, the speed of flow through each valve can be drastically reduced compared with what is required if only one valve—at one end of the engine—is used).

The dynamics of the invention can also be used to initiate detonations at a plurality of stations simultaneously, thereby further increasing frequency and thrust. By using the incompletely burned components of the hot gases—and adjusting the flow of air to utilise them—the fuel can be used more efficiently and a higher specific impulse can be achieved. The invention may also result in a pulse detonation engine and method with efficient combustion even if it does not lead to detonation in each cycle.

In the embodiments, the invention is described to involve injection of a fuel/air mixture, but it is also possible to use genuine fuel injection and supply air (oxidiser) in some other manner or use a substance containing both fuel and oxidiser.

1. A pulse detonation engine (1) comprising a combustion chamber (2), an igniting device (3), and a fuel injection device (4), comprising a plurality of injection valves (5) arranged in an axial direction (20), characterised in that the fuel injection device (4) injects fuel into the combustion chamber (2) which contains residual products (7) after a combustion, inter alia, free radicals.

2. A pulse detonation engine (1) as claimed in claim 1, characterised in that the injection valves (5) open simultaneously to inject fuel into the combustion chamber (5).

3. A pulse detonation engine as claimed in claim 2, characterised in that the injection valves (5) inject a fuel/air mixture into the combustion chamber (2).

4. A pulse detonation engine as claimed in claim 1, characterised in that the pulse detonation engine comprises more than 5 injection valves (5).

5. A pulse detonation engine as claimed in claim 1, characterised in that the pulse detonation engine comprises more than 18 injection valves (5).

6. A pulse detonation engine as claimed in claim 1, characterised in that the nozzles (5×) are arranged for sequence-controlled injection of the fuel into the combustion chamber (2).

7. A pulse detonation engine as claimed in claim 6, characterised in that the injection valves (5ₓ) inject a fuel/air mixture into the combustion chamber (2).

8. A pulse detonation engine as claimed in claim 6, characterised in that an injection valve injects fuel into the combustion chamber (2) shortly before the detonation reaches the injection valve (5ₓ₊₁) to minimise the time during which the fuel and the free radicals are mixed before the detonation front (10) detonates the mixture (8).

9. A pulse detonation engine as claimed in claim 6, characterised in that the pulse detonation engine comprises more than 5 injection valves (5).

10. A pulse detonation engine as claimed in claim 6, characterised in that the pulse detonation engine comprises more than 18 injection valves (5).

11. A pulse detonation engine as claimed in claim 6, characterised in that the speed of the sequence control is close to the CJ speed of the mixture of fuel/air and the residual products.

12. A pulse detonation engine as claimed in claim 1, characterised in that the fuel is in gaseous form, for instance hydrogen gas or acetylene, liquid form, for instance jet propulsion fuel which is injected into the pulse detonation engine as an aerosol, or solid form, for instance boron, which is injected into the pulse detonation engine in the form of a powder.

13. A method of initiating detonations in a pulse detonation engine (1), characterised in that a fuel (6) is injected into a combustion chamber (2) having an axial extension (20); that the fuel is injected into the combustion chamber (2) through a plurality of injection valves (5) arranged along the axial extension (20) of the combustion chamber; that the fuel (6) is mixed with combustion gases (7) remaining in the combustion chamber (2) and comprising free radicals, from the preceding detonation; and that the thus obtained mixture is caused to detonate.

14. A method as claimed in claim 13, characterised in that all injection valves (5) inject fuel simultaneously into the combustion chamber (14).

15. A method as claimed in claim 13, characterised in that the injection valves (5) are controlled individually for the injection of the fuel into the combustion chamber (2).

16. A method as claimed in claim 15, characterised in that the injection valves (5) are sequence controlled at a speed close to the detonation speed of the mixture of fuel/air and the remaining combustion gases.

17. A method as claimed in claim 13, characterised in that the injection valves (5) inject a fuel/air mixture into the combustion chamber (2).
